(19) United States
(12) Patent Application Publication
(10) Pub. No.: US 2004/0046734 A1
(43) Pub. Date: Mar. 11, 2004

(54) Thumb-retained stylus

(76) Inventor: Timothy O. Hart, Shorewood, WI (US)

Correspondence Address: James E. Nilles, NILLES & NILLES, S.C., U.S. Bank Center, Suite 2000, 777 East Wisconsin Avenue, Milwaukee, WI, 53202-5345, US

(21) Appl. No.: 10/254,231

(22) Filed: Sep. 25, 2002

(51) Int. Cl. G09G 5/00

(52) U.S. Cl. 345/156

(57) ABSTRACT

A thumb-retained stylus that allows single-handed operation of a PDA or other hand held device. The thumb-retained stylus comprises a thumb-mounting device and at least one projection extending from the thumb-mounting device.

### BACKGROUND OF THE INVENTION

1. Field of the Invention

The invention relates to a finger-mounted device designed to interact with a touch activated screen.

2. Description of Related Art

Personal computing devices, such as personal digital assistants (PDAs) provide consumers with a convenient, portable, hand-held computing and data retrieval device. Unlike conventional computing devices, a PDA's data input and retrieval is done through a touch-activated screen. Traditionally, a pen-style stylus is used to interact with the PDA. To use a pen-style stylus with the PDA, the operator must hold the PDA in one hand and write on the screen with the pen-style stylus in the other hand. Unfortunately, this method can be particularly inconvenient when a free hand is needed to do another task that requires the user to set down the stylus and pick it up again.

To overcome this problem, finger-mounted devices, which mount over the tip of the index finger, were developed to convert the finger into a stylus or writing instrument. Unfortunately, finger-mounted devices still require a user to devote both hands to the operation of a PDA.

### OBJECTS AND SUMMARY OF THE INVENTION

It is an object of the present invention to provide a stylus, which allows single-handed operation of a PDA or other hand-held device.

The present invention is directed to a thumb-retained stylus for use with a PDA or other hand held device. More specifically, the thumb-retained stylus of the present invention allows a user to activate and manipulate data on a PDA with only one hand by using the thumb as the primary manipulatory digit. The stylus includes a plurality of projections formed on a circular body or ring, through which a user inserts a thumb. The stylus may further include a clip assembly having vent engagement projections configured to engage a surface such as the horizontal vanes of an air conditioning vent in an automobile.

The projections are configured to interact with the touch sensitive screen and the physical buttons on a PDA.

### BRIEF DESCRIPTION OF THE DRAWINGS

At least one preferred exemplary embodiment of the-invention is illustrated in the accompanying drawings in which like reference numerals represent like parts throughout and in which:

FIG. 1 shows a top view of the preferred embodiment of a thumb-retained stylus wherein the mounting device is a ring.

FIG. 2 shows a side view of a thumb-retained stylus mounted on a thumb.

FIG. 3 shows a thumb-retained stylus as used with a PDA.

FIG. 4 shows an alternative embodiment of a thumb-retained stylus having a clip assembly.

### DETAILED DESCRIPTION OF THE PREFERRED EMBODIMENTS

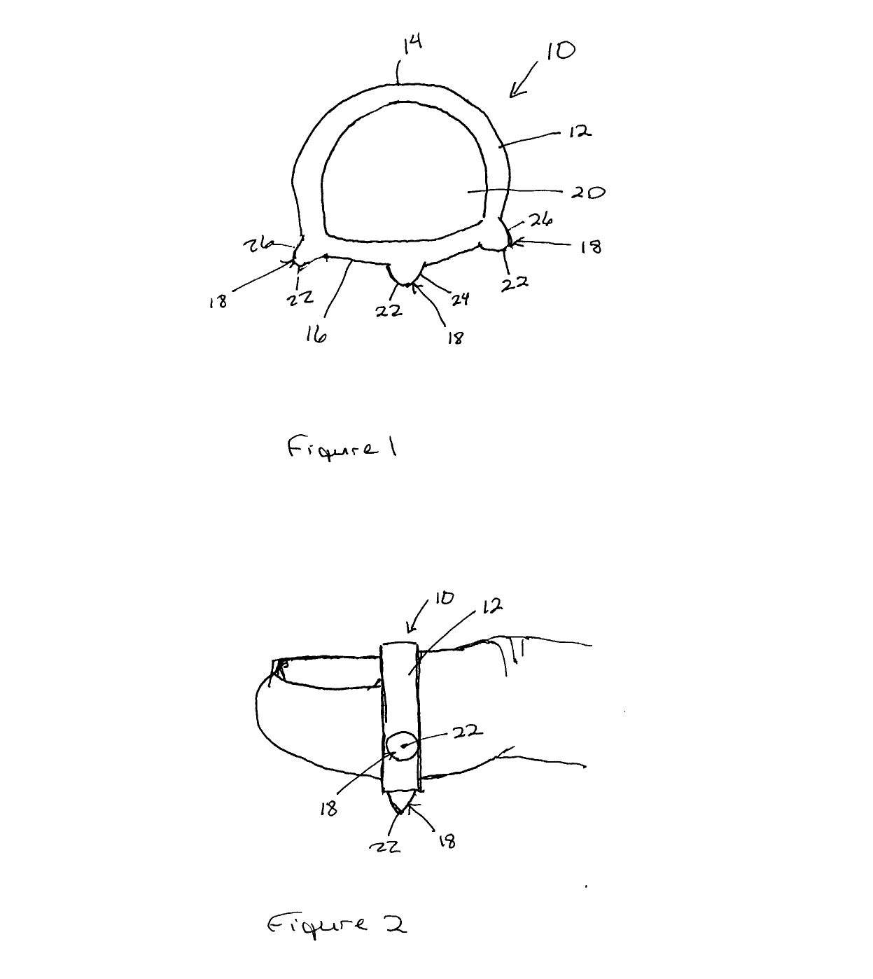

The present invention is directed to a thumb-retained stylus for use with a PDA or other hand held device. As shown in FIGS. 1 and 2, the thumb-retained stylus 10 comprises a mounting device 12 having a top 14 and a bottom 16 and at least one projection 18 extending from the bottom 16 of mounting device 12.

As shown in FIG. 1, the mounting device 12 is preferably a ring having an aperture 16 designed to receive a thumb. The mounting device 12 is formed of a rigid or semi-rigid material such as plastic, metal or any other material that does not exceed the Brinnell hardness of PDA screen surfaces and is safe for contact with human skin. The specific diameter, size and style of the ring may be varied depending on the desired specifications of the user. Alternatively, the mounting device 12 may be a bracket or “expandable ring” which provides an open structure formed of a semi-rigid material such as acrylic, plastic, stamped metal or cast metal. The open structure allows the user to increase or decrease the size of the aperture 20 of the mounting device 12 to a desired size.

The projections 18 extending from the mounting device as shown in FIGS. 1 and 2, are preferably conical in shape wherein the cone narrows as it extends away from the mounting device. This design provides each projection 18 with a tip 22 for precise contact with a PDA screen. Although the projections 18 are preferably conical in shape, 20 they may also be circular, rectangular or any other shape as long as the projection 18 extends into a tip 22, which allows precise contact with a PDA screen.

The thumb-retained stylus 10 preferably includes three projections 18, a medial projection 24 and two lateral projections 26, which extend from the bottom 16 of the mounting device 12. As shown in FIG. 2, each projection 18 preferably extends approximately 2 mm from the mounting device 12 at an angle of 90°.

The projections 18 are positioned along the bottom 16 of the mounting device 12 so that at least one projection 18 will be capable of contacting the PDA when thumb-retained stylus 10 is mounted on either the right or left thumb. The space between each projection 14 is a distance sufficient to prevent the tip 22 of more than one projection 18 from contacting the PDA screen during operation of the PDA, preferably 8 mm.

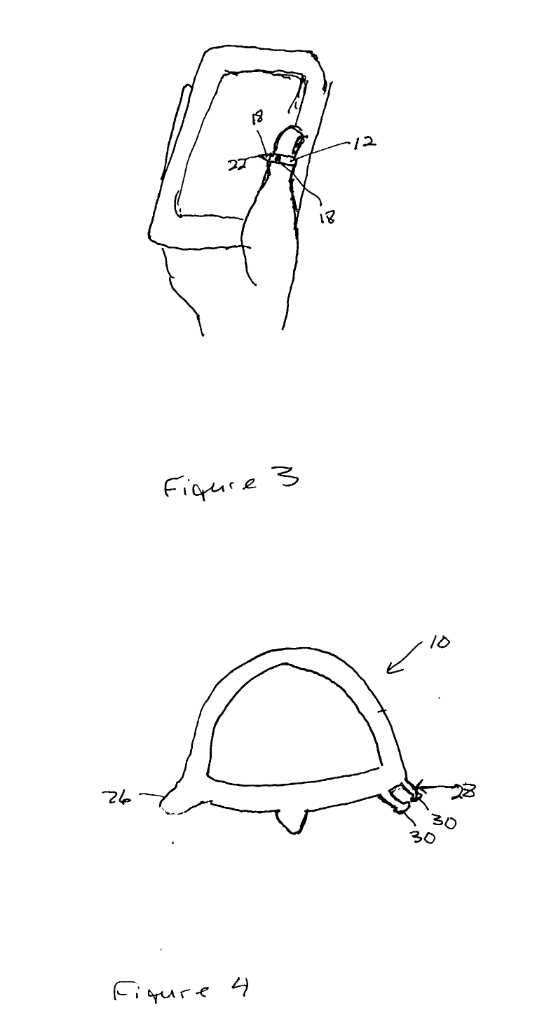

When the thumb-retained stylus 10 is used to operate the PDA screen as shown in FIG. 3, it is positioned on the thumb so that the projections 18 extend away from the bottom of the thumb. The operator then holds the PDA in the palm of his or her hand and then uses side-to-side movements of the thumb to align the projections 18 with specific locations on the PDA screen. Since the thumb-retained stylus 10 is symmetrical, it can be used on either the right or the left hand.

In an alternative embodiment, as shown in FIG. 4, one of the lateral projections 26 is replaced with a clip assembly 28 for mounting the thumb-retained stylus 10 on a storage surface, such as an automotive air-conditioning vent, when it is not being used. The clip assembly 28 comprises two opposing clasp projections 30 for receiving and clasping a storage surface.

Many changes and modifications can be made without departing from the scope and spirit of the invention. Such changes and modifications will become apparent from the appended claims.

I claim:

1. A thumb-retained stylus comprising:
(a) a thumb-mounting device, and
(b) at least one projection extending from the thumb-mounting device.

2. The thumb-retained stylus of claim 1, wherein the thumb-mounting device is a ring.

3. The thumb-retained stylus of claim 2, wherein the thumb-mounting device is a bracket.

4. The thumb-retained stylus of claim 1, further comprising at least one lateral projection and a medial projection.

5. The thumb-retained stylus of claim 1, further comprising a clip assembly extending from the thumb-mounting device.

6. The thumb-retained stylus of claim 1, wherein the stylus is formed of a composition comprising a semi-rigid material such as acrylic, plastic, stamped metal or cast metal.

7. The thumb-retained stylus of claim 1 wherein each projection is separated by a distance of approximately 8 mm-10 mm.
